(19) United States
(12) Patent Application Publication
(10) Pub. No.: US 2011/0314561 A1
(43) Pub. Date: Dec. 22, 2011

(54) Server implemented method and system for securing data

(76) Inventors: Roland Brill, Erlangen (DE); Georg Heidenreich, Erlangen (DE); Wolfgang Klasen, Ottobrunn (DE)

(21) Appl. No.: 12/819,262

(22) Filed: Jun. 21, 2010

(51) Int. Cl. G06F 17/30; G06F 21/24; G06F 15/16

(52) U.S. Cl. 726/29

(57) ABSTRACT

A server implemented method for securing data is provided. The method includes generating a context container for storing data objects transferred to the server during a session with a client, creating, from the data objects in the context container, a plurality of protected zones of data objects, wherein each protected zone includes data objects of a different class of security and creating a reference for each protected zone. Further, the method includes providing the client access to that protected zone via the reference, wherein the reference is non-persistently stored in the server.

### FIELD OF THE INVENTION

The present invention relates to data security and more particularly to a server implemented method and a system for securing data.

### BACKGROUND OF THE INVENTION

In client-server architecture, various tasks or workloads are distributed between providers, which are also known as servers and requesters, which are also known as clients. These clients and server operate over a computer network. A server is a high-performance host that runs one or more server programs which share its resources with one or more clients. A client does not share its resources, but requests a server's content or service function. These clients initiate communication sessions with servers which respond to incoming requests.

Client server architecture is used in various settings such as Inter-sectoral health settings, remote care settings, telemedicine, e-Health, e-commerce related sites and so on. Generally, a client requests information from a server which transmits the information to the client via the internet as a communication channel. As an example, data related to a patient is located in the server which provides access to the client requesting information about the patient. This patient related data has to be protected to ensure patient's privacy as required by legislation. Security mechanisms are implemented on servers to secure patient related data, however, increasing the security measures slows down the performance of the server.

Currently, a client accessing the server has a server-side container, which is also known as a session object, is isolated from other containers of other clients accessing the server. This server-side container stores all temporary infoimation and the progress of client's interaction during the session and persists on the server till the end of the session or for a limited duration of time as defined in the server.

However, there is no separation of data within the session object for a given client and application functions designed to enforce the security of data accidentally propagate protected data within the session object or to other session objects meant for other clients. Further, there exists no systematic approach to separate data at application-level.

It is therefore desirable to separate protected, secured and related data and also avoid propagating data to the other session object.

### SUMMARY OF THE INVENTION

Briefly in accordance with an aspect of the present invention, a server implemented method for securing data is presented. The method includes generating a context container for storing data objects transferred to the server during a session with a client, creating, from the data objects in the context container, a plurality of protected zones of data objects, wherein each protected zone includes data objects of a different class of security and creating a reference for each protected zone. Further, the method includes providing the client an access to that protected zone via the reference, wherein the reference is non-persistently stored in the server.

In accordance with another aspect of the present invention, a server system for securing data is presented. The system includes a server module for receiving requests from a client, comprising a data security module for generating a context container for storing data objects transferred to the server during a session with a client, creating, from the data objects in the context container, a plurality of protected zones of data objects, wherein each protected zone includes data objects of a different class of security and creating a reference for each protected zone and providing the client an access to that protected zone via the reference. The system also includes a memory coupled to the server module for storing the context container and the reference, such that the reference is non-persistently stored in the memory.

In accordance with yet another aspect of the present invention, a computer readable medium is presented. The computer readable medium embodies instructions which when executed by a processor of a server, causes the processor to perform a method comprising generating a context container for storing data objects transferred to the server during a session with a client, creating, from the data objects in the context container, a plurality of protected zones of data objects, wherein each protected zone includes data objects of a different class of security and creating a reference for each protected zone. Further, the method includes providing the client an access to that protected zone via the reference, wherein the reference is non-persistently stored in the server.

### BRIEF DESCRIPTION OF THE DRAWINGS

The present invention is further described hereinafter with reference to illustrated embodiments shown in the accompanying drawings, in which:

FIG. 1 is a schematic diagram of a client server arrangement;

FIG. 2 shows a schematic diagram of a server system depicting a data security module;

FIG. 3 shows the server having a context container divided into zone;

FIG. 4 shows another embodiment of accessing a zone in the server; and

FIG. 5 depicts a context container in the server divided into nested zones.

### DETAILED DESCRIPTION OF THE INVENTION

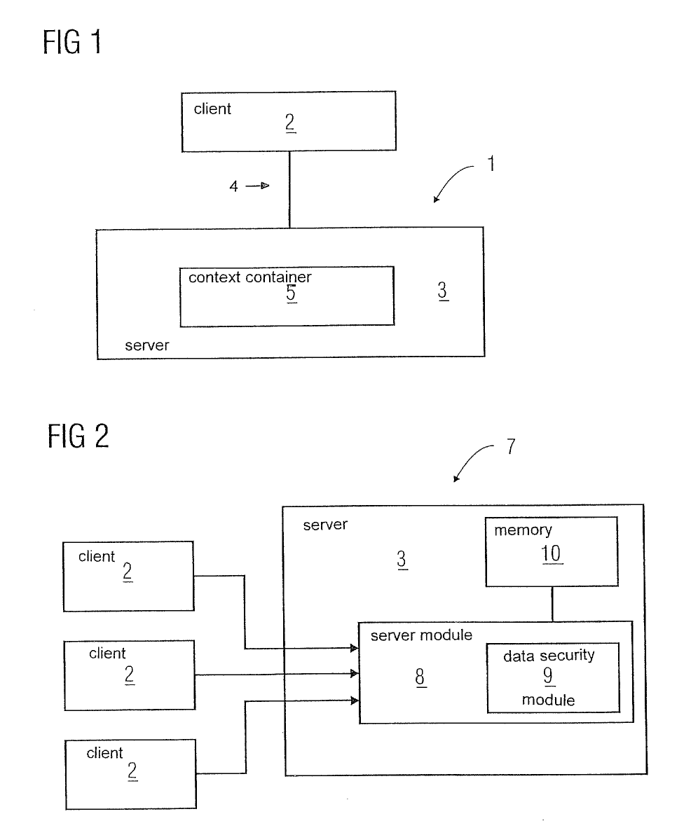

FIG. 1 is a diagrammatical illustration of a client server arrangement 1. A client 2 is typically a workstation or a personal computer and a server 3 is typically a computer having hardware and software components that provide a sophisticated set of services, or operations, for use by the client 2. The client 2 is shown as communicating with the server 3 over a communication link 4. This communication link 4 is typically a local area network connection, a wide area network connection, a connection over telephone lines or a combination of connection methods. In one example, the client 2 communicates with the server 3 using a transmission control protocol/Internet protocol (TCP/IP). For the majority of internet communications, the client 2 communicates with the server 3 using a hypertext transfer protocol (HTTP) which is transmitted between the client 2 and the server 3. Although, the embodiments have been described with reference to server offering services via the interne, it may however be noted that the server offering services via some other network, via some service bus or other communication channels to connect clients to the server are also covered within the scope of the present technique.

During the communication between the client 2 and the server 3, a collection or sequence of requests which may be HTTP requests over a period of time known as a session are stored as a data object in the server 3. It may be noted that if a plurality of clients are accessing or requesting information from the server 3, each client has a data object which is also known as the server-side container is stored in the server 3. These data objects are isolated from the other data objects for other clients. The data object stores all temporary information and the progress of client's interaction during the session and persists on the server 3 till the end of the session or for a limited duration of time as defined in the server 3.

In accordance with aspects of the present technique, an aggregate of data objects which are transferred to the server 3 is created, this aggregate of data objects is known as a context container 5. This context container 5 is stored in the server 3 as depicted. The context container 5 separates the secured and unsecured data as will be described hereinafter.

FIG. 2 is a diagrammatical illustration of a server system 7 in accordance with aspects of the present technique. As previously noted the server system 7 implements a method for securing data. As an example, data could be information about a patient in a hospital. In other example, data could be the credit card details of a customer visiting an online shopping site. The server system 7 includes a server module 8 for receiving requests from a plurality of clients, such as the client 2 of FIG. 1. It would be understood that the server module 8 may include any hardware and/or software, For example, in one embodiment, the server module 8 may include a CPU, board/blade hardware and a standard operating system. In another embodiment the server module 8 may include dedicated hardware without a standard operating system. As an example, the client 2 may request the server system 7 to provide information about the patient admitted to the hospital. This information may include personal details of patient such as first name, last name, date of birth, sex, blood group, previous illness history and so forth. The server module 8 includes a data security module 9 which is configured to generate a context container, such as the context container 5 of FIG. 1, for storing data objects transferred to the server system 7 during the session with the client 2. Thereafter, the data security module 9 creates from the data objects in the context container 5 (see FIG. 1), a plurality of protected zones of data objects. This context container is stored in a memory 10 of the server system. The memory 10 is coupled to the server module 8 for storing data. In one embodiment, the memory 10 may be a non-volatile memory such as a hard disk, floppy disk, magnetic tapes, a CD ROM, etc, or any other suitable computer-readable medium. It would be understood that the data security module 9 may include any hardware and/or software,

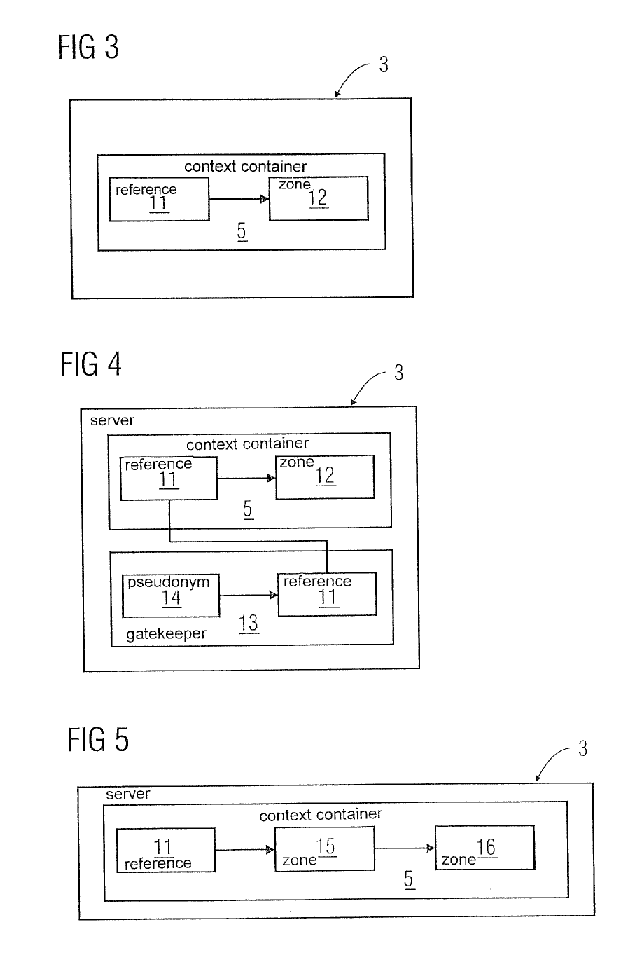

FIG. 3 is a diagrammatical illustration depicting a zone in the context container of the server. As illustrated in FIG. 3, the context container contains a protected zone 12 that stores data objects. To access data from the protected zone 12 a secret reference 11 is created. It may be noted that the data security module 9 of FIG. 2 creates the secret reference 11 for accessing data in the protected zone 12. In accordance with aspects of the present technique, the reference may include a ticket, a token, a certificate, a physical address, a password, or combinations thereof.

In accordance with aspects of the present technique, the context container 5 contains a plurality of protected zones, such as the protected zone 12. Each protected zone in the context container 5 includes data objects. These data objects are arranged according to the levels of security. As an example, the security level may be high level, medium level and low level. It may however be noted that the security levels may be defined according to the requirements for a particular application. Furthermore, the data security module 9 is configured to create a plurality of secret references for each protected zone and provide the client 2 access to a protected zone via the corresponding secret reference.

With continuing reference to FIG. 2, the server module 8 is configured to delete the secret reference 11 (see FIG. 3) from the memory 10 after the end of the session for the client 2; hence, the secret reference 11 (see FIG. 3) is stored non-persistently in the server system 7. More particularly, the secret reference 11 is stored in the memory 10 of the server system 7 till the completion of the session.

Additionally, the server module 8 is configured to lock access to data in the protected zone 12 of the context container 5 after the data in the protected zone 12 has been accessed. This enables that a secured data once accessed is not transferred to other data objects in the context container 5.

Moreover, the server module 8 is configured to create a log version of the context container 5 for a session with a respective client, such as the client 2. The log version of the context container 5 for the session with the client 2 is stored in the memory 10. This context container 5 may be accessed by the same client as a part of an “undo” or a “backward” functionality and hence the log version of the context container 5 is able to identify whether the same client is accessing the context container 5, and thus the server module 8 is able to provide the same data to the client 2.

FIG. 4 is a diagrammatical illustration depicting another embodiment for accessing a zone in the context container 5 of the server 3. The protected zone 12 in the present embodiment is accessed by a pseudonym 14. As used herein, the term “pseudonym” is a fictitious name which may include a handle, a user name, a login name, avatar or a screen name. The pseudonym 14 is provided to the client 2 to access data objects in the protected zone 12. When the client 2 wants to access data from the zone it enters the pseudonym 14 which is resolved by the server 3 into the secret reference 11 and hence the server 3 works as a gatekeeper 13 to the secured data. The secret reference 11 is able to access the protected zone 12 in the context container 5 as depicted. As previously noted, the secret reference 11 may include a ticket, a token, a certificate, a physical address, a password, or combinations thereof. The client 2 is granted access based on the pseudonyms, which may be restricted based on the time slot, the identity of a user and other information such as login name to restrict access and ensure permissions to the client 2 requesting access to the secured data.

FIG. 5 is another embodiment depicting access to a protected zone in the server 3. As illustrated, the context container 5 contains a first zone 15 and a second zone 16. Access to the second zone 16 is achieved via the first zone 15. In this embodiment, a secret which is a reference, such as the secret reference 11 in FIG. 3 and FIG. 4 accesses the first zone 15 in the context container 5. The second zone 16 is accessed through the first zone 15. This ensures high level of security since the client 2 has to first access the first zone 15 through the secret reference 11 and thereafter the second zone 16, such an arrangement ensures fine-grained access restrictions.

The above-discussed server implemented method and the server system 7 have several advantages such as providing a secure application, protection of secure data as well as a cost effective solution to data security issues in a client-server arrangement 1. While only certain features of the invention have been illustrated and described herein, many modifications and changes will occur to those skilled in the art. It is, therefore, to be understood that the appended claims are intended to cover all such modifications and changes as fall within the true spirit of the invention.

1. A server implemented method for securing data, comprising
generating a context container for storing data objects transferred to the server during a session with a client;
creating, from the data objects in the context container, a plurality of protected zones of data objects, wherein each protected zone includes data objects of a different class of security;
creating a reference for each protected zone; and
providing the client an access to that protected zone via the reference, wherein the reference is non-persistently stored in the server.

2. The server implemented method according to claim 1, wherein the reference is stored in the server till completion of the session.

3. The server implemented method according to claim 1, wherein the reference comprises a ticket, a token, a certificate, a physical address, a password or combinations thereof.

4. The server implemented method according to claim 1, wherein the reference to access the protected zone is a pseudonym.

5. The server implemented method according to claim 4, wherein the pseudonym is provided to the client to access data objects in the protected zone.

6. The server implemented method according to claim 1, further comprising locking an access to data in the protected zone after the data in the protected zone is accessed.

7. The server implemented method according to claim 1, further comprising creating a log version of the context container for the session with the client.

8. The server implemented method according to claim 1, wherein access to the protected zone is provided via another protected zone.

9. The server implemented method according to claim 5, wherein the pseudonym is recognizable by the server.

10. A server system, comprising:
a server module for receiving requests from a client, comprising:
a data security module for
generating a context container for storing data objects transferred to the server system during a session with the client;
creating, from the data objects in the context container, a plurality of protected zones of data objects, wherein each protected zone includes data objects of a different class of security;
creating a reference for each protected zone; and
providing the client an access to that protected zone via the reference; and
a memory coupled to the server module for storing the context container and the reference such that the reference is non-persistently stored in the memory.

11. The server system of claim 10, wherein the data security module is further configured to delete the reference after the completion of the session.

12. The server system of claim 10, wherein the data security module is further configured to create a pseudonym to access the protected zone.

13. The server system of claim 10, wherein the server module is configured to provide pseudonym to the client.

14. The server system of claim 10, wherein the server module is further configured to lock an access to data in the protected zone after the data in the protected zone is accessed.

15. The server system of claim 10, wherein the server module is configured to create a log version of the context container for the session with the client.

16. The server system of claim 15, wherein the log version of the context container for the session with the client is stored in the memory.

17. A computer readable medium, embodying instructions which when executed by a processor of a server, causes the processor to perform a method comprising:
generating a context container for storing data objects transferred to the server during a session with a client;
creating, from the data objects in the context container, a plurality of protected zones of data objects, wherein each protected zone includes data objects of a different class of security;
creating a reference for each protected zone; and
providing the client an access to that protected zone via the reference, wherein the reference is non-persistently stored in the server.

18. The computer readable medium according to claim 17, wherein the reference is stored in the server till completion of the session.

19. The computer readable medium according to claim 17, wherein the reference to access the protected zone is a pseudonym.

20. The computer readable medium according to claim 19, wherein the pseudonym is provided to the client to access data objects in the protected zone.
